(19) United States
(12) Patent Application Publication
(10) Pub. No.: US 2022/0390052 A1
(43) Pub. Date: Dec. 8, 2022

(54) TUBE FITTING

(71) Applicant: NIPPON PILLAR PACKING CO., LTD., Osaka-shi (JP)

(72) Inventors: Tomoyuki KOIKE, Osaka-shi (JP); Tomohiro ADACHI, Osaka-shi (JP); Yuto TSUCHIYA, Osaka-shi (JP)

(73) Assignee: NIPPON PILLAR PACKING CO., LTD., Osaka-shi (JP)

(21) Appl. No.: 17/776,863

(22) PCT Filed: Sep. 23, 2020
(86) PCT No.: PCT/JP2020/035782

§ 371 Date: May 13, 2022

(30) Foreign Application Priority Data
Nov. 15, 2019 (JP) 2019-207185

(51) Int. Cl. F16L 33/22; F16L 33/00; F16L 33/28

(52) U.S. Cl. CPC F16L 33/226; F16L 33/006; F16L 33/28

(57) ABSTRACT

A fitting body includes a tubular end whose outer periphery has an external thread and whose inner periphery has an annular groove or protrusion. A sleeve connects a tube to the tubular end of the fitting body. A union nut includes a first axial end that receives the tube therein and a second axial end to be screwed onto the external thread of the fitting body. The fitting body includes first and second regulating portions extending in directions that intersect an axial direction of the fitting body to contact the union nut being screwed onto the external thread and then sharply raise torque to be transmitted through the union nut to a hand of a worker. When being screwed onto the external thread, the union nut contacts the first regulating portion and subsequently the second regulating portion.

### TECHNICAL FIELD

The invention relates to tube fittings for connecting tubes to fluid devices.

### BACKGROUND ART

In semiconductor processing, various liquid chemicals and ultrapure water are used for application of resists to wafers, cleaning of wafers, and the like. Piping systems treating such liquids, such as tubes, fittings, valves, and pumps, are included in production lines of semiconductor devices. Such piping systems are characterized by the following features: All portions to be directly wetted by the liquids are made of fluoropolymers; and maintenance such as cleaning is required at relatively frequent intervals. The former aims at preventing metallic contamination from forming crystal defects of semiconductors and deteriorating electric characteristics thereof. The latter aims at preventing particulates from causing defectively manufactured traces and at preventing organic materials from causing abnormal film formation. In view of these features, the piping systems are required to be easy to assemble and disassemble, as well as to have excellent sealing properties.

Some tube fittings in the piping systems use a sleeve, which is also referred to as an inner ring, for connection to a tube. A first axial end of the sleeve is press-fitted in an open end of the tube, and a second axial end of the sleeve is connected and secured to the body of a tube fitting with a union nut. A force that the sleeve is received from the union nut squeezing the sleeve is used to seal gaps between the sleeve and the fitting body. To regulate the strength of the force to such an extent as not to distort any portions of the tube fitting, and thus, make the tube fitting keep a high seal performance, an axial position of the union nut, i.e., a squeezing position, has to be properly set. In addition, to facilitate a process of screwing the union nut, a worker has to be allowed to easily perceive whether the squeezing position is proper or not. For example, the tube fittings disclosed in Patent Literatures 1 and 2 include a ring member placed between a union nut and a fitting body. The union nut reaching a proper squeezing position contacts the ring member, and thus, it is blocked from further advancing. As a result, the union nut is unlikely to advance beyond the proper squeezing position. In addition, a worker can easily perceive whether the union nut is in the proper squeezing position or not.

### CITATION LIST

### Patent Literature

Patent Literature 1: JP H10-332070 A

Patent Literature 2: JP H11-094178 A

### SUMMARY OF INVENTION

Like the above-described ring member, a structure on a path of the union nut to block the advance thereof will be hereinafter referred to as a regulating portion. In particular, the regulating portion extends in a direction that intersects an axial direction of the union nut. Thus, when the union nut is screwed onto an external thread of the fitting body, the regulating portion contacts the union nut and exerts a circumferential force thereon to sharply raise torque to be transmitted through the union nut to a hand of a worker. Since a common tube fitting has the regulating portion made of plastic material like other components, if the worker erroneously screws the union nut to an excessive degree regardless of the arrival of the union nut at a proper squeezing position, excessive pressure from the union nut can distort the regulating portion. The distorted regulating portion cannot completely block the union nut from advancing beyond the proper squeezing position. As a result, the whole of the fitting body can be distorted to deteriorate the seal performance of the tube fitting. If the union nut is screwed much more tightly, the tube fitting will also have a risk of being damaged such as twist off of the fitting body.

An object of the invention is to solve the above-mentioned problems, in particular, to provide a tube fitting that can reliably prevent its union nut from advancing beyond a proper squeezing position.

According to one aspect of the invention, a tube fitting includes a fitting body, a sleeve, and a union nut. The fitting body includes a tubular end whose outer periphery has an external thread and whose inner periphery has an annular groove or an annular protrusion. The sleeve connects a tube to the tubular end of the fitting body. A first axial end of the union nut receives the tube therein, and a second axial end thereof is screwed onto the external thread of the fitting body. The fitting body further includes first and second regulating portions that extend in directions that intersect an axial direction of the fitting body such that the union nut, when being screwed onto the external thread, contacts the first regulating portion and subsequently the second regulating portion and transmits to a hand of a worker both torque sharply raised by the contact with the first regulating portion and torque sharply raised by the contact with the second regulating portion.

The first regulating portion may, when and after contacting the union nut, deform to allow the union nut to further advance along the external thread. The second regulating portion may, by contacting the union nut, prevent the union nut from further advancing along the external thread. The first regulating portion may be located radially outside the external thread. The second regulating portion may be located radially inside the external thread.

The fitting body may further include a third regulating portion that extends in a direction intersecting the axial direction of the fitting body and that, when the union nut is screwed onto the external thread, contacts the union nut to sharply raise torque to be transmitted through the union nut to the hand of the worker. The union nut may, when being screwed onto the external thread, contact the third regulating portion after contacting the second regulating portion.

The above-mentioned tube fitting according to the invention includes the union nut that, when being screwed onto the external thread of the fitting body, contacts the first regulating portion and subsequently the second regulating portion. Since such double contact with the regulating portions prevents the advance of the union nut, it is unlikely that the union nut will advance beyond a proper squeezing position. In addition, once the union nut contacts the first regulating portion, torque transmitted through the union nut to a hand of a worker sharply rises, and accordingly, the tube fitting allows the worker to feel the union nut approaching the proper squeezing position before the arrival thereof at the position, thereby easily alerting the worker to excessively screwing the union nut. Thus, the tube fitting can reliably prevent the union nut from advancing beyond the proper squeezing position.

### BREIF DESCRIPTION OF DRAWINGS

FIG. 1 is a perspective view showing an appearance of a tube fitting according to a first embodiment of the invention;

FIG. 2 is a partial cross-section view along a line II-II in FIG. 1;

FIGS. 3A and 3B are partial cross-section views similar to that of FIG. 2, showing in time order how the union nut is screwed onto the external thread of the fitting body;

FIGS. 4A and 4B are partial cross-section views of a tube fitting according to a second embodiment of the invention, showing in time order how the union nut is screwed onto the external thread of the fitting body;

FIGS. 5A, 5B, and 5C are partial cross-section views of a tube fitting according to a third embodiment of the invention, showing in time order how the union nut is screwed onto the external thread of the fitting body; and

FIGS. 6A and 6B are partial cross-section views of a modification of the tube fitting according to the first embodiment of the invention, showing in time order how the union nut is screwed onto the external thread of the fitting body.

### DESCRIPTION OF EMBODIMENTS

The following explains embodiments of the invention with reference to the drawings.

### First Embodiment

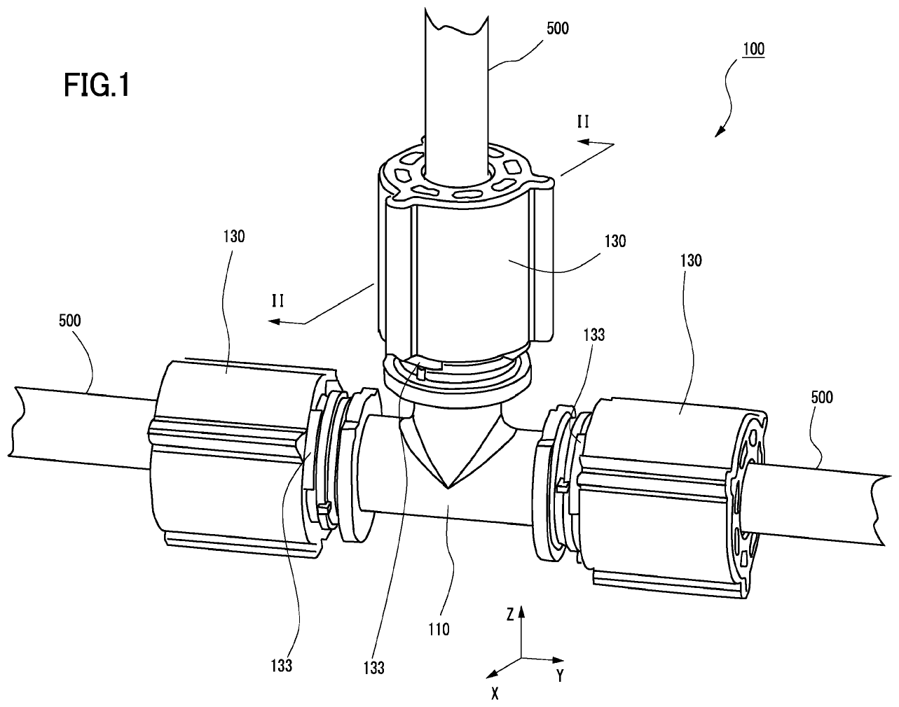

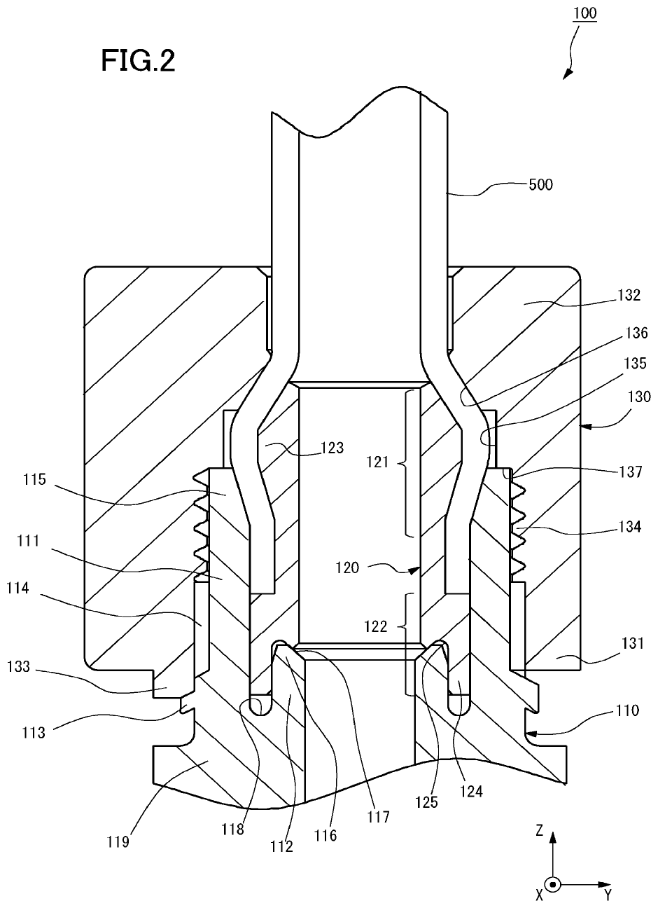

FIG. 1 is a perspective view showing an appearance of a tube fitting 100 according to a first embodiment of the invention, and FIG. 2 is a partial cross-section view of the tube fitting 100 along a line II-II in FIG. 1. Tube fittings can have various shapes depending on types of joint. For example, the tube fitting 100 is a type called as a tee to be used to connect three tubes 500 to form a letter T. The tubes 500 are white or translucent tubes made of a fluoropolymer such as polytetrafluoroethylene (PTFE) or perfluoroalkoxy alkane (PFA). The tube fitting 100 has ends to be each connected to one of the tubes 500. Each of the ends has a similar structure including a fitting body 110, a sleeve 120, and a union nut 130.

The fitting body 110 is a cylindrical member made of a fluoropolymer such as polyvinylidene fluoride (PVDF), PTFE, or PFA. The fitting body 110, each end thereof to be exact (the same applies hereinafter), has a double-layered structure consisting of an outer sleeve 111 and an inner sleeve 112, which project coaxially from a common base end 119 in the same direction, i.e., the positive Z-axis direction in FIG. 2. The outer sleeve 111 includes a flange 113 and an external thread 114 on its outer periphery. The flange 113 radially extends from the base end of the outer sleeve 111. The external thread 114 extends axially, i.e., in the positive Z-axis direction, from a side of the flange 113 toward the tip 115 of the outer sleeve 111. The inner sleeve 112 is an annular protrusion whose tip 116 is shorter than the tip 115 of the outer sleeve 111. The tip 116 of the inner sleeve 112 includes a slope 117 with respect to the axial direction, i.e., the Z-axis direction, to have inner diameters increasing with increasing axial distance from the base end 119 of the fitting body 110, i.e., with increasing Z coordinate value. Within the inner space of the outer sleeve 111, a range from the tip 115 of the outer sleeve 111 to the tip 116 of the inner sleeve 112 contains a sleeve or inner ring 120. A volume across which an inner periphery of the outer sleeve 111 and an outer periphery of the inner sleeve 112 face each other forms an annular groove 118.

The sleeve 120 is a cylindrical member made of a fluoropolymer such as PTFE or PFA, which is arranged coaxially with the fitting body 110. A tip 121 of the sleeve 120 is press-fitted in an open end of the tube 500, and a base end 122 of the sleeve 120 is fit in the inner sleeve 112 and annular groove 118 of the fitting body 110. Thus, the base end 119 and inner sleeve 112 of the fitting body 110, the sleeve 120, and the tube 500 allow their inner spaces to communicate with each other to form a flow channel for liquid chemicals, ultrapure water, or the like.

The tip 121 of the sleeve 120 includes a bulge 123, whose outer diameters gently vary with locations in the axial direction, i.e., the Z-axis direction, and whose center portion in the axial direction, i.e., the Z-axis direction, includes a portion of the maximum outer diameter, i.e., a peek. Since the outer diameter of the peek is larger than the inner diameter of the tube 500, the bulge 123 is press-fitted in the open end of the tube 500 to expand it from the inside. Elastomeric forces of the tube 500 that resist the expansion causes the open end of the tube 500 to enclose the bulge 123 of the sleeve 120 so that the open end is firmly fixed to the tip 121 of the sleeve 120.

The base end 122 of the sleeve 120 includes an annular protrusion 124 and an annular groove 125. The annular protrusion 124 projects from the whole circumference of the base end 122 in the axial direction, i.e., the negative Z-axis direction in FIGS. 1 and 2, to place its tip in the annular groove 118 of the fitting body 110. Since the inner diameter of the annular protrusion 124 is slightly smaller than the outer diameter of the inner sleeve 112 of the fitting body 110, the annular protrusion 124 is placed in the annular groove 118 of the fitting body 110 by press fit or interference fit, thereby bringing the inner periphery of the annular protrusion 124 into close contact with the outer periphery of the inner sleeve 112. The annular groove 125 of the sleeve 120 is located inside the base end of the annular protrusion 124. Within the annular groove 125, the tip 116 of the inner sleeve 112 of the fitting body 110 is placed. The annular groove 125 includes a wall angled toward the same direction as the slope 117 of the tip 116 of the inner sleeve 112 and in contact with the slope 117 of the tip 116 of the inner sleeve 112.

The union nut 130 is a cylindrical member made of a fluoropolymer such as PTFE, PFA, or PVDF, which coaxially surrounds the fitting body 110, the sleeve 120, and the tube 500. From an end of the union nut 130 nearer to the fitting body 110, i.e., the tip 131 thereof, one or more, e.g., three, arc-shaped protrusions 133 project axially, i.e., in the negative Z-axis direction (cf. FIG. 1). The arc-shaped protrusions 133 are equally spaced along the rim of an opening of the tip 131 of the union nut 130 to contact and deform the flange 113 of the fitting body 110. Inside another end of the union nut 130 further from the fitting body 110, i.e., the base end 132 thereof, the tube 500 is coaxially placed.

The inner periphery of the union nut 130 includes an internal thread 134, a step 135, and a tapered surface 136, which are listed in order of increasing axial distance from the fitting body 110, i.e., increasing Z coordinate value. The internal thread 134 extends from the tip 131 of the union nut 130 close to the tip 115 of the outer sleeve 111 of the fitting body 110 and engages with or is screwed onto the external thread 114 of the fitting body 110. The step 135 is a portion with an inner diameter narrower than that of the internal thread 134 and faces a portion of the tube 500 expanded by the bulge 123 of the sleeve 120. At the boundary between the internal thread 134 and the step 135, an annular surface 137 extends in a direction intersecting the axial direction. The annular surface 137 is located to be able to contact the tip 115 of the outer sleeve 111 of the fitting body 110. The tapered surface 136 is a portion with inner diameters that are narrower than the inner diameter of the step 135 and decrease with increasing axial distance from the step 135, i.e., with increasing Z coordinate value. The tapered surface 136 contacts a portion of the tube 500 close to the opening of the tip of the sleeve 120 so that, when the internal thread 134 of the union nut 130 is screwed onto the external thread 114 of the fitting body 110, pressure of the union nut 130 is applied from the tapered surface 136 to the tube 500, and in turn, transmitted through the sleeve 120 to a portion of the inner sleeve 112 of the fitting body 110 in contact with the sleeve 120. This results in close contact between the inner periphery of the annular protrusion 124 of the sleeve 120 and the outer periphery of the inner sleeve 112 of the fitting body 110, and between the annular groove 125 of the sleeve 120 and the slope 117 of the inner sleeve 112 of the fitting body 110. Thus, gaps between the fitting body 110 and the sleeve 120 are sealed.

Advance of the union nut 130 along the external thread 114 of the fitting body 110, i.e. in the negative Z-axis direction, is doubly blocked by contact between the flange 113 of the fitting body 110 and the arc-shaped protrusions 133 of the union nut 130 and contact between the tip 115 of the outer sleeve 111 of the fitting body 110 and the annular surface 137 of the union nut 130. In other words, both the flange 113 and the tip 115 of the outer sleeve 111 serve as regulating portions for the union nut 130.

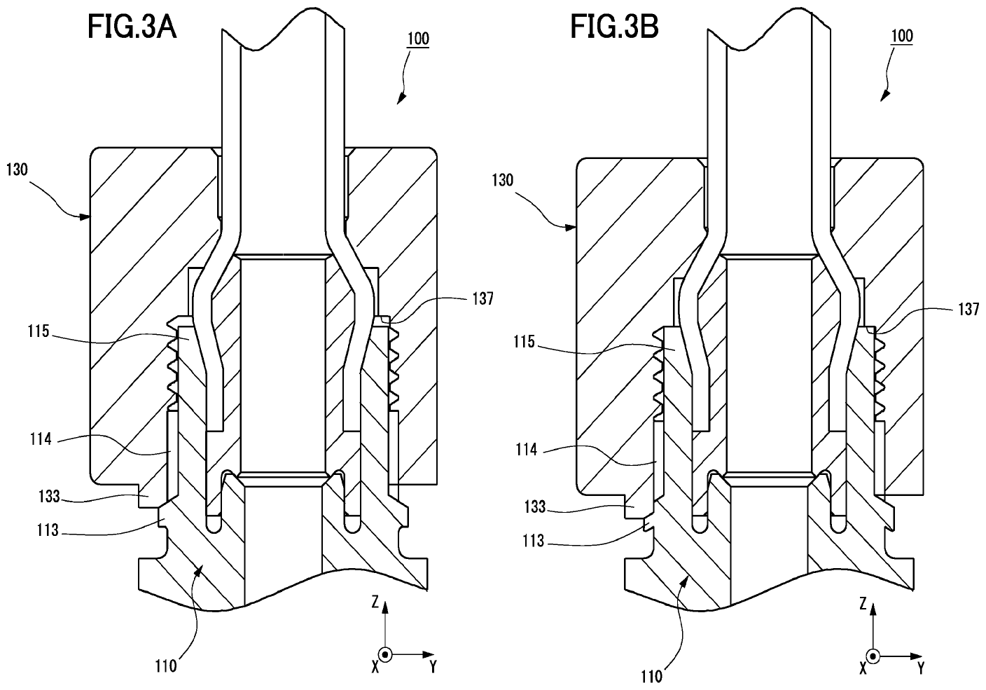

FIGS. 3A and 3B are partial cross-section views similar to that of FIG. 2, showing in time order how the union nut 130 is screwed onto the external thread 114 of the fitting body 110. The union nut 130, when beginning to be screwed onto the external thread 114, first brings the arc-shaped protrusions 133 into contact with the flange 113 of the fitting body 110 as shown in FIG. 3A. Then, torque transmitted from the union nut 130 to a hand of a worker sharply rises. For example, the torque after the contact of the arc-shaped protrusions 133 with the flange 113 rises by 10%-20% compared to that before the contact. On the other hand, the contact deforms the flange 113 as shown in FIG. 3B, and thus, the union nut 130 continues to advance along the external thread 114. After that, the union nut 130 brings the annular surface 137 into contact with the tip 115 of the outer sleeve 111 of the fitting body 110, which again sharply raises the torque transmitted to the hand of the worker. The axial position, i.e., the Z coordinate value, of the union nut 130 at that time has been designed as the proper squeezing position. Since the tip 115 of the outer sleeve 111 is thicker than the flange 113, it is hardly deformed by the contact with the union nut 130. Accordingly, there is a high likelihood that, in response to the further sharp rise of the torque transmitted to the hand of the worker, the worker will stop the union nut 130 before the tip 115 of the outer sleeve 111 is deformed.

### Advantages of First Embodiment

In the tube fitting 100 according to the first embodiment of the invention, the union nut 130, when being screwed onto the external thread 114 of the fitting body 110, first brings the arc-shaped protrusions 133 into contact with the flange 113 of the fitting body 110 and subsequently brings the annular surface 137 into contact with the tip 115 of the outer sleeve 111 of the fitting body 110. Thus, the union nut 130 is prevented from advancing by double contact with the regulating portions 113 and 115 of the fitting body 110, and accordingly, it hardly advances beyond the proper squeezing position. In addition, the torque transmitted through the union nut 130 to the hand of the worker sharply rises when the arc-shaped protrusion 133 of the union nut 130 contacts the flange 113 of the fitting body 110. This allows the worker to feel the union nut 130 approaching the proper squeezing position before the arrival thereof at the position, i.e., before the annular surface 137 reaches the tip 115 of the outer sleeve 111. Thereby, the tube fitting 100 can alert the worker to excessively screwing the union nut 130 before the arrival thereof at the proper squeezing position. Thus, the tube fitting 100 can reliably prevent the union nut 130 from advancing beyond the proper squeezing position.

It is preferable that the contact of the arc-shaped protrusions 133 of the union nut 130 with the flange 113 of the fitting body 110 is earlier than the contact of the annular surface 137 of the union nut 130 with the tip 115 of the outer sleeve 111 of the fitting body 110. The reason is as follows; since the flange 113 is located radially outside the external thread 114, the deformation of the flange 113 due to the contact with the union nut 130 hardly affects both the external thread 114 and the sleeve 120. Since the deformation of the flange 113 neither deforms nor tilts the external thread 114, the union nut 130 can be screwed onto the external thread 114 to reach the proper squeezing position. In addition, stress caused by the deformation of the flange 113 does not affect stress transmitted from the tapered surface 136 of the union nut 130 to the sleeve 120, and accordingly, there is no risk of reduction in seal performance of the inner sleeve 112 of the fitting body 110 and the sleeve 120.

### Second Embodiment

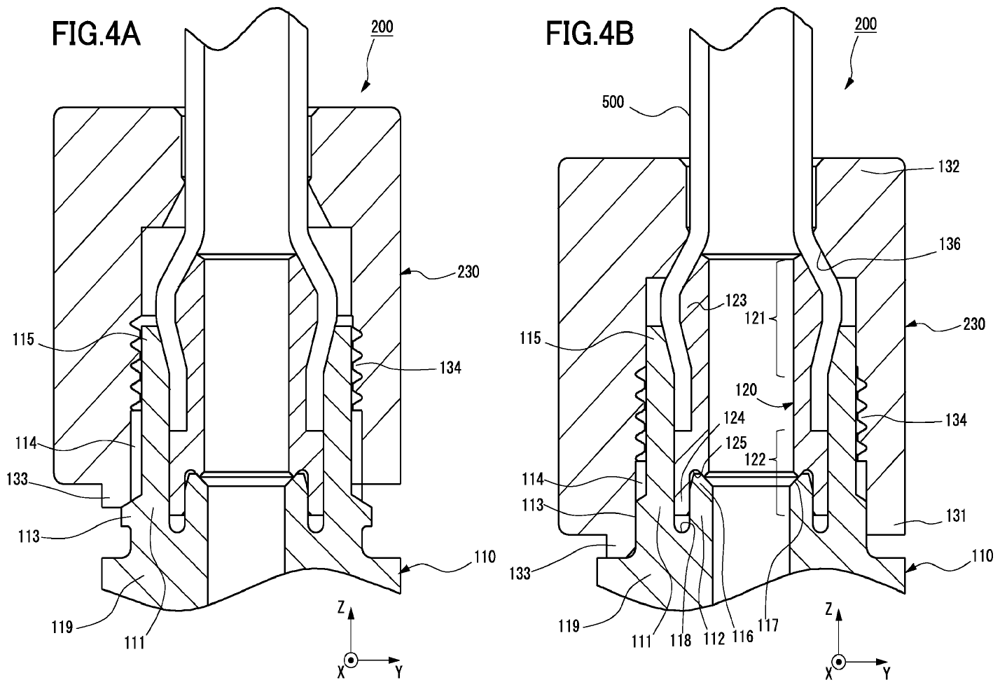

FIGS. 4A and 4B are partial cross-section views of a tube fitting 200 according to a second embodiment of the invention, showing in time order how its union nut 230 is screwed onto an external thread 114 of its fitting body 110. The tube fitting 200 according to the second embodiment is different from the tube fitting 100 according to the first embodiment in the structure of the union nut 230. Other components are similar in structure to those of the tube fitting 100 according to the first embodiment. In FIGS. 4A and 4B, components similar in structure between the tube fitting 100 according to the first embodiment and the tube fitting 200 according to the second embodiment are marked with the same reference numbers. Details of the similar components can be found in the description on the first embodiment.

As shown in FIG. 4B, the inner periphery of the union nut 230, in contrast to that according to the first embodiment, does not include the step 135 between the internal thread 134 and the tapered surface 136, thus not contacting the tip 115 of the outer sleeve 111 of the fitting body 110. On the other hand, the arc-shaped protrusions 133 of the union nut 230 squashes and travels over the flange 113 of the fitting body 110 to reach and contact the base end 119 of the fitting body 110.

The advance of the union nut 230 along the external thread 114 of the fitting body 110 is doubly blocked by contact of the flange 113 of the fitting body 110 with the inner periphery of the union nut 230 and contact of the base end 119 of the fitting body 110 with the arc-shaped protrusions 133 of the union nut 230. In other words, both the flange 113 and the base end 119 serve as regulating portions for the union nut 230.

The union nut 230, when beginning to be screwed onto the external thread 114 of the fitting body 110, first brings the arc-shaped protrusions 133 into contact with the flange 113 of the fitting body 110 as shown in FIG. 4A. This contact sharply raises torque transmitted from the union nut 230 to a hand of a worker. On the other hand, the contact deforms the flange 113, and thus, the union nut 230 continues to advance along the external thread 114. After that, the arc-shaped protrusions 133 of the union nut 230 squashes and travels over the flange 113 to reach and contact the base end 119 of the fitting body 110, as shown in FIG. 4B, which again sharply raises the torque transmitted to the hand of the worker. The axial position, i.e., the Z coordinate value, of the union nut 230 at that time has been designed as the proper squeezing position. Since the base end 119 is thicker than the flange 113, it is hardly deformed by the contact with the union nut 230. Accordingly, there is a high likelihood that, in response to the further sharp rise of the torque transmitted to the hand of the worker, the worker will stop the union nut 230 before the base end 119 is deformed.

### Advantages of Second Embodiment

In the tube fitting 200 according to the second embodiment of the invention, the union nut 230, when being screwed onto the external thread 114 of the fitting body 110, first brings the arc-shaped protrusions 133 of the union nut 230 into contact with the flange 113 of the fitting body 110 and moves them over the flange 113, and subsequently brings them into contact with the base end 119 of the fitting body 110. Thus, the union nut 230 is prevented from advancing by double contact with the fitting body 110, and accordingly, it hardly advances beyond the proper squeezing position. In addition, the torque transmitted through the union nut 230 to the hand of the worker sharply rises when the arc-shaped protrusion 133 contacts the flange 113. This allows the worker to feel the union nut 230 approaching the proper squeezing position before the arrival thereof at the position, i.e., before the arc-shaped protrusion 133 reaches the base end 119. Thereby, the tube fitting 200 can alert the worker to excessively screwing the union nut 230 before the arrival thereof at the proper squeezing position. Thus, the tube fitting 200 can reliably prevent the union nut 230 from advancing beyond the proper squeezing position.

The last portion of the union nut 130 according to the first embodiment that contacts the regulating portion of the fitting body 110 is the annular surface 137, which is located radially inside the external thread 114 of the fitting body 110. In contrast, the last portion of the union nut 230 according to the second embodiment is the arc-shaped protrusions 133, which are located radially outside the external thread 114. Accordingly, if each axis of the union nuts 130 and 230 tilts at an angle from the axis of the fitting body 110, the tube fitting 100 according to the first embodiment can allow the squeezing position of its union nut to deviate less from a proper one than the tube fitting 200 according to the second embodiment.

### Third Embodiment

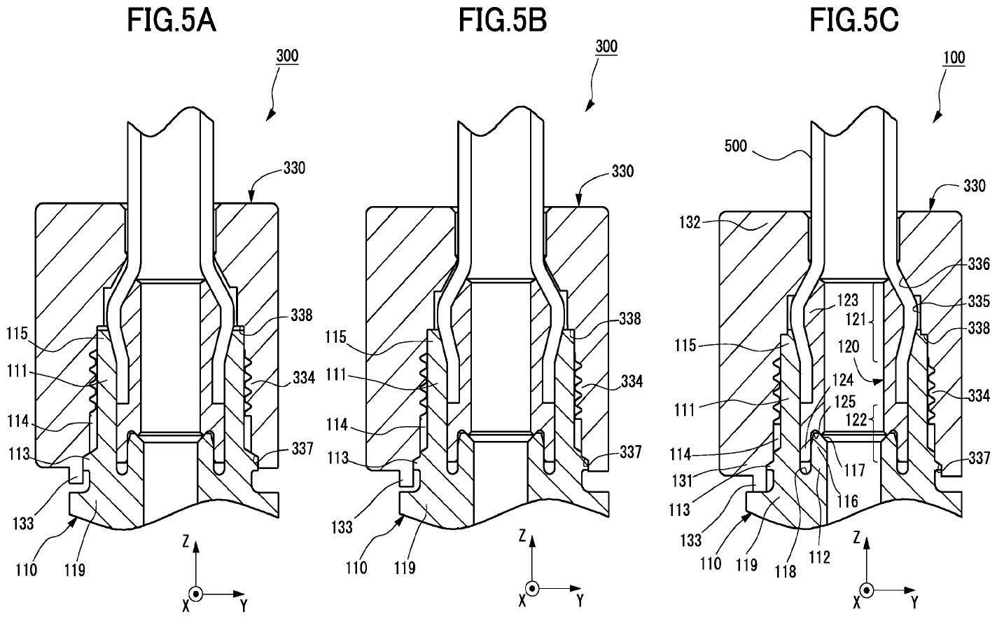

FIGS. 5A, 5B, and 5C are partial cross-section views of a tube fitting 300 according to a third embodiment of the invention, showing in time order how its union nut 330 is screwed onto an external thread 114 of its fitting body 110. The tube fitting 300 according to the third embodiment is different from the tube fitting 100 according to the first embodiment in the structure of the union nut 330. Other components are similar in structure to those of the tube fitting 100 according to the first embodiment. In FIGS. 5A, 5B, and 5C, components similar in structure between the tube fitting 100 according to the first embodiment and the tube fitting 300 according to the third embodiment are marked with the same reference numbers. Details of the similar components can be found in the description on the first embodiment.

As shown in FIG. 5C, arc-shaped protrusions 133 of the union nut 330 contact the base end 119 of the fitting body 110. The inner periphery of the union nut 330 includes an internal thread 334, a step 335, and a tapered surface 336, which are listed in order of increasing axial distance from the fitting body 110, i.e., increasing Z coordinate value. The internal thread 334 extends from an axial position slightly inside the rim of the opening of the tip 131 of the union nut 330, i.e. a position with a Z coordinate value slightly larger than that of the rim, close to the tip 115 of the outer sleeve 111 of the fitting body 110 and engages with or is screwed onto the external thread 114 of the fitting body 110. At the boundary between the rim of the opening of the tip 131 of the union nut 330 and the internal thread 334, a first annular surface 337 extends in a direction intersecting the axial direction. The first annular surface 337 contacts and deforms the flange 113 of the fitting body 110. The step 335 is a portion with an inner diameter narrower than that of the internal thread 334 and faces a portion of the tube 500 expanded by the bulge 123 of the sleeve 120. At the boundary between the internal thread 334 and the step 335, a second annular surface 338 extends in a direction intersecting the axial direction. The second annular surface 338 contacts and deforms the tip 115 of the outer sleeve 111 of the fitting body 110. The tapered surface 336 is a portion with inner diameters that are narrower than that of the step 335 and decrease with increasing axial distance from the step 335, i.e., with increasing Z coordinate value. The tapered surface 336, like the tapered surface 136 according to the first embodiment, contacts a portion of the tube 500 close to the opening of the tip of the sleeve 120 so that, when the internal thread 334 is screwed onto the external thread 114, pressure of the union nut 330 is applied from the tapered surface 336 to the tube 500, and in turn, transmitted through the sleeve 120 to a portion of the inner sleeve 112 of the fitting body 110 in contact with the sleeve 120.

The advance of the union nut 330 along the external thread 114 of the fitting body 110 is triply blocked by contact between the flange 113 of the fitting body 110 and the first annular surface 337 of the union nut 330, contact between the tip 115 of the outer sleeve 111 of the fitting body 110 and the second annular surface 338 of the union nut 330, and contact between the base end 119 of the fitting body 110 and the arc-shaped protrusions 133 of the union nut 330. In other words, all of the flange 113, the tip 115 of the outer sleeve 111, and the base end 119 serve as regulating portions for the union nut 330.

The union nut 330, when beginning to be screwed onto the external thread 114 of the fitting body 110, first brings the first annular surface 337 into contact with the flange 113 of the fitting body 110 as shown in FIG. 5A. This contact sharply raises torque transmitted from the union nut 330 to a hand of a worker. On the other hand, the contact deforms the flange 113 as shown in FIG. 5B, and thus, the union nut 330 continues to advance along the external thread 114. The union nut 330 next brings the second annular surface 338 into contact with the tip 115 of the outer sleeve 111 of the fitting body 110 as shown in FIG. 5B. This contact again sharply raises the torque transmitted from the union nut 330 to the hand of the worker. On the other hand, the contact deforms the tip 115 of the outer sleeve 111 as shown in FIG. 5C, and thus, the union nut 330 continues to advance along the external thread 114. The union nut 330 subsequently brings the arc-shaped protrusions 133 into contact with the base end 119 of the fitting body 110 as shown in FIG. 5C. This contact also sharply raises the torque transmitted from the union nut 330 to the hand of the worker. The axial position, i.e., the Z coordinate value, of the union nut 330 at that time has been designed as the proper squeezing position. Since the base end 119 is thicker than either of the flange 113 and the tip 115 of the outer sleeve 111, it is hardly deformed by the contact with the union nut 330. Accordingly, there is a high likelihood that, in response to the further sharp rise of the torque transmitted to the hand of the worker, the worker will stop the union nut 330 before the base end 119 is deformed.

### Advantages of Third Embodiment

In the tube fitting 300 according to the third embodiment of the invention, the union nut 330, when being screwed onto the external thread 114 of the fitting body 110, first brings the first annular surface 337 of the union nut 330 into contact with the flange 113 of the fitting body 110, next the second annular surface 338 of the union nut 330 into contact with the tip 115 of the outer sleeve 111 of the fitting body 110, and subsequently the arc-shaped protrusions 133 of the union nut 330 into contact with the base end 119 of the fitting body 110. Thus, the union nut 330 is prevented from advancing by triple contact with the fitting body 110, and accordingly, it hardly advances beyond the proper squeezing position. In addition, the torque transmitted through the union nut 330 to the hand of the worker sharply rises twice; when the first annular surface 337 contacts the flange 113 and when the second annular surface 338 contacts the tip 115 of the outer sleeve 111. This allows the worker to feel the union nut 330 approaching the proper squeezing position in two stages before the arrival thereof at the position, i.e., before the arc-shaped protrusion 133 reaches the base end 119. Thereby, the tube fitting 300 can alert the worker to excessively screwing the union nut 330 twice before the arrival thereof at the proper squeezing position. Thus, the tube fitting 300 can reliably prevent the union nut 330 from advancing beyond the proper squeezing position.

### Modifications

(1) The whole shape of the tube fitting 100 shown in FIG. 1 is nothing more than one example. The tube fitting may have another different shape such as elbow, bent, cross, or socket. The tube fitting may be one provided to a fluid device such as a valve or a filter, i.e., a tube connecting port thereof. In this case, the tube fitting may have a structure integrated with the body of the fluid device. In any case, a portion of the tube fitting to be connected to a tube only has to be similar in structure to that according to the first embodiment shown in FIG. 2, that according to the second embodiment shown in FIG. 4, or that according to the third embodiment shown in FIG. 5.

(2) The number, circumferential length, and circumferential interval of the arc-shaped protrusions 133 of the union nut 130 shown in FIG. 1 are nothing more than one example. For example, the union nut 130 may have a single arc-shaped protrusion 133, which may further extend throughout the whole circumference of the union nut 130.

(3) In the tube fitting 300 according to the third embodiment, three portions of the union nut 330, i.e., the arc-shaped protrusions 133, the first annular surface 337, and the second annular surface 338 contact the regulating portions 119, 113, and 115 of the fitting body 110. However, the union nut 330 may lack the second annular surface 338 like the union nut 230 according to the second embodiment, and its advance may be doubly blocked by the arc- shaped protrusions 133 and the first annular surface 337.

(4) The structure of the joint between the fitting body 110 and the sleeve 120 shown in each of FIGS. 2-5 is nothing more than one example and can be modified in various manners.

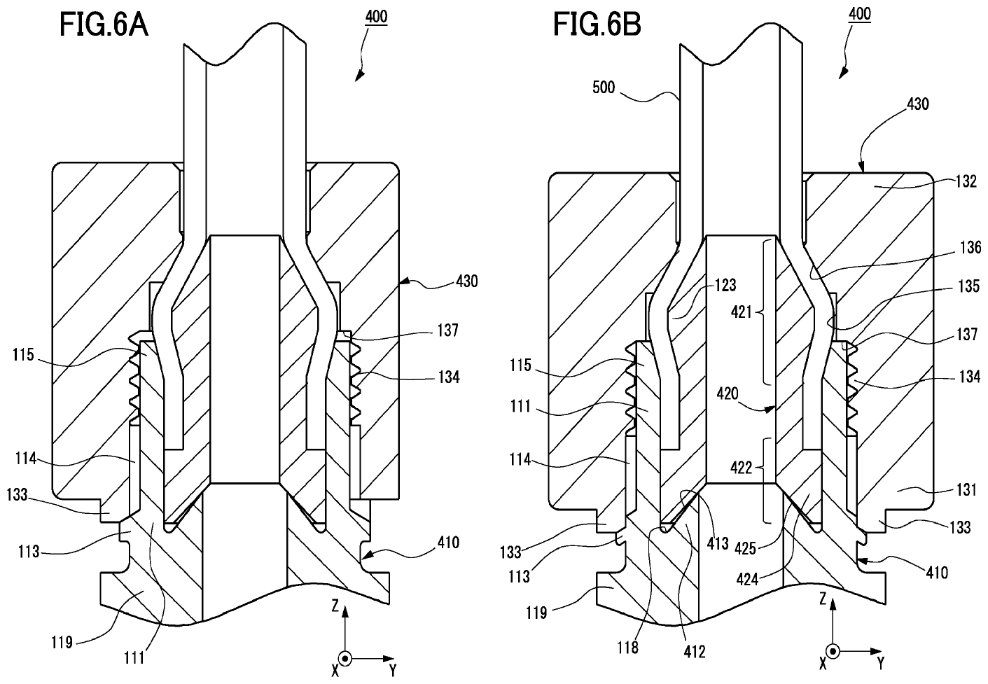

FIGS. 6A and 6B are partial cross-section views of a modification 400 of the tube fitting 100 according to the first embodiment, showing in time order how a union nut 130 is screwed onto an external thread 114 of a fitting body 410. Except for a joint between the fitting body 410 and a sleeve 420, the modified tube fitting 400 is similar in structure to the tube fitting 100 according to the first embodiment. In FIGS. 6A and 6B, components similar in structure between the tube fitting 100 according to the first embodiment and the modified tube fitting 400 are marked with the same reference numbers. Details of the similar components can be found in the description on the first embodiment.

The fitting body 410 shown in FIG. 6B is different from the fitting body 110 shown in FIG. 2 in the shape of an inner sleeve 412. The inner sleeve 412 is an annular protrusion whose outer periphery 413 is tapered throughout its length to have outer diameters decreasing with increasing axial distance from the base end 119 of the fitting body 410, i.e., with increasing Z coordinate value.

The sleeve 420 shown in FIG. 6B is different from the sleeve 120 shown in FIG. 2 in the shape of its base end 422. The base end 422 includes an annular protrusion 424 that projects from the whole circumference of the base end 422 in the axial direction, i.e., the negative Z-axis direction in FIGS. 6A and 6B, and places its tip in an annular groove 118 of the fitting body 410. The inner periphery 425 of the annular protrusion 424 is tapered throughout its length to have inner diameters increasing with increasing axial distance from the tip 421 of the sleeve 420, i.e., with decreasing Z coordinate value. In other words, the inner periphery 425 of the annular protrusion 424 has the same inclination angle with respect to the axial direction, i.e., the Z-axis direction, as the outer periphery 413 of the inner sleeve 412, and thus, a broad area of the inner periphery 425 contacts the outer periphery 413.

The union nut 130, when beginning to be screwed onto the external thread 114 of the fitting body 410, first brings the arc-shaped protrusions 133 into contact with the flange 113 of the fitting body 410 as shown in FIG. 6A. The contact then deforms the flange 113 as shown in FIG. 6B, and thus, the union nut 130 continues to advance along the external thread 114. After that, the union nut 130 brings the annular surface 137 into contact with the tip 115 of the outer sleeve 111 of the fitting body 410 as shown in FIG. 6B. The axial position, i.e., the Z coordinate value, of the union nut 130 at that time has been designed as the proper squeezing position.

When the internal thread 134 of the union nut 130 is screwed onto the external thread 114 of the fitting body 410, pressure of the union nut 130 is applied from the tapered surface 136 thereof to the outer periphery of the tube 500, and in turn, transmitted through the sleeve 420 to a portion of the outer periphery 413 of the inner sleeve 412 of the fitting body 410 in contact with the inner periphery 425 of the annular protrusion 424 of the sleeve 420. This results in close contact between the outer periphery 413 and the inner periphery 425. Thus, gaps between the fitting body 410 and the sleeve 420 are sealed.

1. A tube fitting comprising:
a fitting body including:
a tubular end whose outer periphery has an external thread and whose inner periphery has an annular groove or an annular protrusion; and
first and second regulating portions extending in directions that intersect an axial direction of the fitting body;
a sleeve configured to connect a tube to the tubular end of the fitting body; and
a union nut including
a first axial end configured to receive the tube therein and
a second axial end configured to be screwed onto the external thread of the fitting body,
the union nut configured to, when being screwed onto the external thread, due to the respective directions of the first and second regulating portions, contact the first regulating portion and subsequently the second regulating portion and transmit to a hand of a worker both torque sharply raised by the contact with the first regulating portion and torque sharply raised by the contact with the second regulating portion.

2. The tube fitting according to claim 1, wherein
the first regulating portion, when and after contacting the union nut, deforms to allow the union nut to further advance along the external thread, and
the second regulating portion, by contacting the union nut, prevents the union nut from further advancing along the external thread.

3. The tube fitting according to claim 1, wherein
the first regulating portion is located radially outside the external thread.

4. The tube fitting according to claim 1, wherein
the second regulating portion is located radially inside the external thread.

5. The tube fitting according to claim 1, wherein
the fitting body further comprises
a third regulating portion that extends in a direction intersecting the axial direction of the fitting body and that is configured to, when the union nut is screwed onto the external thread, contact the union nut to sharply raise torque to be transmitted through the union nut to the hand of the worker and
the union nut is configured to, when being screwed onto the external thread, contact the third regulating portion after contacting the second regulating portion.
